(19) United States
(12) Patent Application Publication
(10) Pub. No.: US 2013/0224559 A1
(43) Pub. Date: Aug. 29, 2013

(54) SEPARATOR FOR NONAQUEOUS ELECTROLYTE SECONDARY BATTERY, METHOD FOR PRODUCING THE SAME, AND NONAQUEOUS ELECTROLYTE SECONDARY BATTERY

(71) Applicants: Takahiro Furutani, Kyoto (JP); Eri Kojima, Kyoto (JP); Toshiyuki Watanabe, Kyoto (JP); Kunihiko Koyama, Kyoto (JP)

(72) Inventors: Takahiro Furutani, Kyoto (JP); Eri Kojima, Kyoto (JP); Toshiyuki Watanabe, Kyoto (JP); Kunihiko Koyama, Kyoto (JP)

(73) Assignee: HITACHI, LTD., Tokyo (JP)

(21) Appl. No.: 13/702,985

(22) PCT Filed: Feb. 23, 2012
(86) PCT No.: PCT/JP12/54413

§ 371 Date: Dec. 7, 2012

(51) Int. Cl. H01M 2/16

(52) U.S. Cl. CPC H01M 2/162
USPC 429/145; 429/249; 429/211; 427/487

(57) ABSTRACT

A separator for a nonaqueous electrolyte secondary battery that at least includes a resin (A) having a crosslinked structure, which is obtained by irradiating with an energy ray an oligomer polymerizable by irradiation with an energy ray. The separator has an average pore size of 0.005 to 0.5 μm, an air permeability of 50 sec/100 mL or more and less than 500 sec/100 mL, where the air permeability is expressed as a Gurley value, and a thermal shrinkage of less than 2% at 175° C. The separator for a nonaqueous secondary battery can be produced by the production method of the present invention, which includes the steps of: applying to a substrate a separator forming composition containing the oligomer, two or more kinds of solvents having different polarity from each other, and the like; irradiating the applied composition with an energy ray; and drying the energy ray-irradiated composition.

### TECHNICAL FIELD

The present invention relates to a nonaqueous electrolyte secondary battery with excellent load and charge-discharge cycle characteristics, a separator with which the nonaqueous electrolyte secondary battery can be formed, and a method for producing the separator.

### BACKGROUND ART

Nonaqueous electrolyte secondary batteries such as lithium secondary batteries are characterized by their high energy density, and thus have been widely used as power sources for portable devices such as portable phones and notebook personal computers. As portable devices become more sophisticated, achieving improvements in a variety of battery characteristics as well as the level of safety presents a significant challenge.

For currently available lithium secondary batteries, a polyolefin-based porous film having a thickness of about 20 to 30 μm, for example, is used as a separator for being interposed between positive and negative electrodes. However, when producing such a polyolefin-based porous film, a complicated process such as biaxial drawing or extraction of a pore-forming agent is currently used to form fine and uniform pores in the film, which results in an increased cost and thus makes the separator expensive.

As the raw material of the separator, polyethylene having a melting point of about 120 to 140° C. is used in order to ensure a so-called shutdown effect by which the resin constituting the separator is melted at a temperature lower than or equal to the thermal runaway temperature of a battery to close the pores, and the internal resistance of the battery is thereby increased, thus improving the level of safety of the battery at the time of short circuiting or the like. However, when the battery temperature further increases after the shutdown, for example, the melted polyethylene becomes likely to flow, which may result in the so-called meltdown that causes damage to the separator. In such a case, the positive and negative electrodes come into direct contact with each other, leading to a further increase in the temperature. And in a worst-case scenario, the battery may catch fire.

In order to prevent short circuiting caused by such meltdown, methods of using separators made of heat-resistant resin have been proposed. For example, Patent Document 1 proposes a nonaqueous electrolyte secondary battery including positive and negative electrodes whose surface is provided with an isolation material that has a crosslinked structure and functions as a separator. By the technique described in Patent Document 1, it is possible to improve the level of safety and reliability of the nonaqueous electrolyte secondary battery at elevated temperatures.

### PRIOR ART DOCUMENT

### Patent Document

Patent Document 1: JP 2010-170770 A

### DISCLOSURE OF INVENTION

### Problem to be Solved by the Invention

It is expected that even the nonaqueous electrolyte secondary battery with an improved level of safety and reliability (especially the level of safety and reliability at elevated temperatures) as above will need to have much improved load and charge-discharge cycle characteristics as devices using nonaqueous electrolyte secondary batteries will become more sophisticated in the future. In this regard, the technique described in Patent Document 1 still has a room for improvement.

With the foregoing in mind, it is an object of the present invention to provide a nonaqueous electrolyte secondary battery with excellent load and charge-discharge cycle characteristics, a separator with which the nonaqueous electrolyte secondary battery can be formed, and a method for producing the separator.

### Means for Solving Problem

In order to achieve the above object, the separator for a nonaqueous electrolyte secondary battery of the present invention includes at least a resin (A) having a crosslinked structure. The resin (A) having a crosslinked structure is obtained by irradiating with an energy ray at least an oligomer polymerizable by irradiation with an energy ray. The separator has an average pore size of 0.01 to 0.5 μm, an air permeability of 45 sec/100 mL or more and less than 590 sec/100 mL, where the air permeability is expressed as a Gurley value, and a thermal shrinkage of less than 2% at 175° C.

The separator for a nonaqueous electrolyte secondary battery of the present invention can be produced by the production method of the present invention, which includes the steps of applying to a substrate a separator forming composition at least containing the oligomer polymerizable by irradiation with an energy ray, and two or more kinds of solvents having different polarity from each other; irradiating with an energy ray a coating of the separator forming composition applied to the substrate to form the resin (A) having a crosslinked structure; and drying the energy ray-irradiated coating of the separator forming composition to form pores.

Further, the nonaqueous electrolyte secondary battery of the present invention at least includes as components: a positive electrode including a positive electrode mixture layer formed on a surface of a current collector; a negative electrode including a negative electrode mixture layer formed on a surface of a current collector; and a porous separator. The separator is the separator for a nonaqueous electrolyte secondary battery of the present invention.

### Effects of the Invention

According to the present invention, it is possible to provide a nonaqueous electrolyte secondary battery with excellent load and charge-discharge cycle characteristics, a separator with which the nonaqueous electrolyte secondary battery can be formed, and a method for producing the separator.

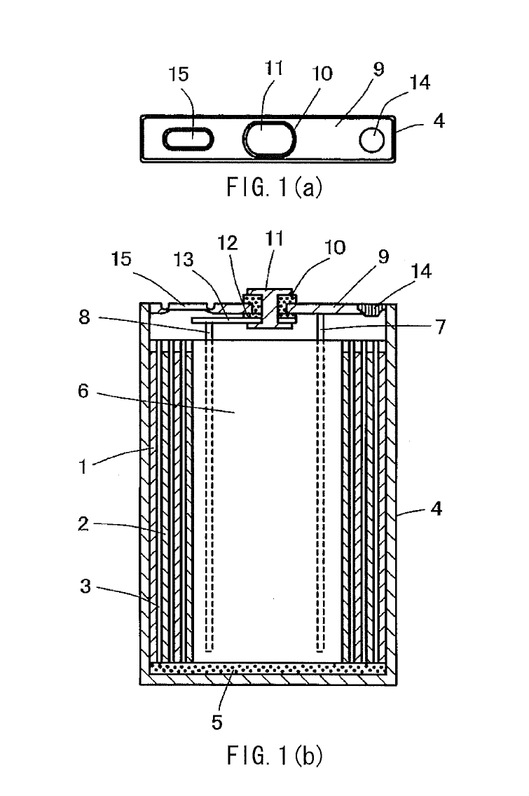

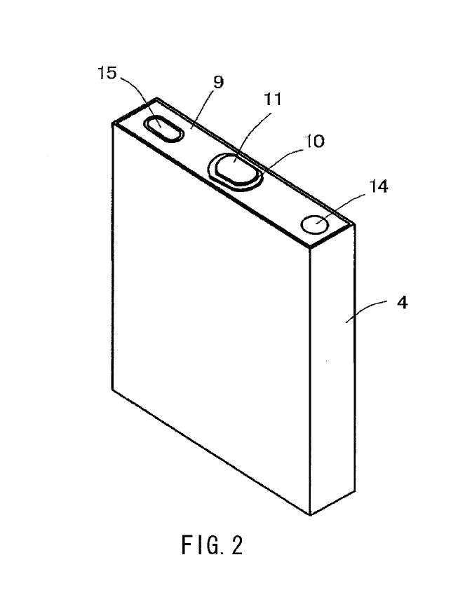

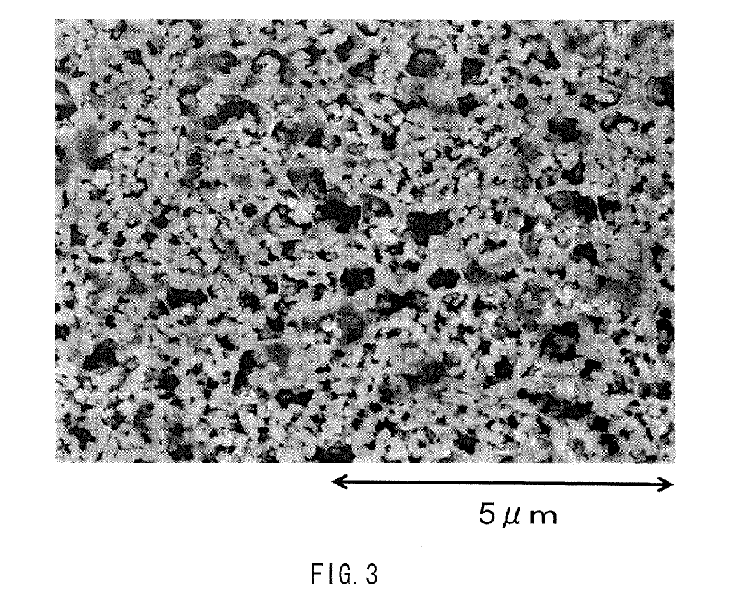

### BRIEF DESCRIPTION OF DRAWINGS

[FIG. 1] FIG. 1 includes schematic views of an exemplary nonaqueous electrolyte secondary battery of the present invention: (a) is a plan view and (b) is a partial longitudinal sectional view of the nonaqueous electrolyte secondary battery.

[FIG. 2] FIG. 2 is a perspective view of the nonaqueous electrolyte secondary battery shown in FIG. 1.

[FIG. 3] FIG. 3 is a scanning electron microscope image of a cross section of a separator used in a nonaqueous electrolyte secondary battery of Example 1.

### DESCRIPTION OF THE INVENTION

The separator for a nonaqueous electrolyte secondary battery (hereinafter it may be simply referred to as the “separator”) of the present invention at least includes a resin (A) having a crosslinked structure.

The resin (A) used in the separator of the present invention is a resin (crosslinked resin) at least partially having a crosslinked structure. Therefore, even if the internal temperature of a nonaqueous electrolyte secondary battery including the separator of the present invention (i.e., the nonaqueous electrolyte secondary battery of the present invention) is elevated, the deformation of the separator due to shrinkage and melting of the resin (A) is less likely to occur. Since the separator can thus maintain its shape in a favorable manner, the occurrence of short circuit between the positive and negative electrodes is suppressed. For these reasons, the nonaqueous electrolyte secondary battery of the present invention including the separator of the present invention can show an excellent level of safety at elevated temperatures.

Specifically, the separator of the present invention containing the resin (A) has a thermal shrinkage of less than 2% at 175° C., meaning that the level of thermal deformation is exceptionally reduced.

As mentioned above, generally, separators for nonaqueous electrolyte secondary batteries are produced through a process involving drawing, and pores of these separators each have a shallow depth in the separator thickness direction (i.e., the pores are two-dimensional), and such anisotropy that the diameter is exceptionally large in a certain direction (the separator production direction) and exceptionally small in the direction perpendicular to the certain direction when the pores are seen from the separator surface side.

In contrast, the separator of the present invention can be produced without undergoing the drawing process as above, so that it has a plurality of three-dimensional pores with no anisotropy and having an average pore size of 0.01 μm or more and 0.5 μm or less. In this way, the separator of the present invention has a number of fine pores that are relatively uniform in shape, so that stable lithium ion permeability can be ensured throughout the separator as a whole. Therefore, a nonaqueous electrolyte secondary battery using the separator of the present invention (i.e., the nonaqueous electrolyte secondary battery of the present invention) has favorable battery characteristics such as load characteristics.

The shape of the pores of the separator of the present invention (the three-dimensional shape with no anisotropy) can be expressed in pore circularity, for example. Specifically, the pores of the separator of the present invention have a circularity of preferably 0.5 or more and preferably less than 0.8, and more preferably 0.75 or less.

The pores of the separator of the present invention having the above average pore size can be formed by producing the separator containing the resin (A) by the method of the present invention (described later in detail).

Further, as a result of the pores having the above average pore size, the separator of the present invention can have an air permeability expressed in a Gurley value of 45 sec/100 mL or more and less than 590 sec/100 mL, resulting in favorable lithium ion permeability. Thus, even if a nonaqueous electrolyte secondary battery using the separator of the present invention (i.e., the nonaqueous electrolyte secondary battery of the present invention) is charged and discharged repeatedly, lithium dendrites are less likely to be formed, and a decline in the capacity resulting from a micro-short circuit owing to lithium dendrites is thus less likely to occur. The battery therefore has improved charge-discharge cycle characteristics.

The thermal shrinkage of the separator at 175° C., the average pore size, the circularity and the air permeability as used herein are respectively determined by the methods described later in Examples.

The resin (A) used in the separator of the present invention is obtained by irradiating with an energy ray an oligomer polymerizable by irradiation with an energy ray to polymerize the oligomer. As a result of the resin (A) being formed by the polymerization of the oligomer, it is possible to configure the separator to be highly flexible and less likely to come off from, for example, an electrode or a porous base when they are combined into one piece (described later in detail). In addition, Tg of the resin (A) can be easily adjusted to be in a range of the below-described values.

The glass transition temperature (Tg) of the resin (A) is preferably higher than 0° C., and more preferably 10° C. or higher, and preferably lower than 80° C., and more preferably 60° C. or lower. With the resin (A) having such Tg, it is possible to form pores having the above-mentioned average pore size, and preferably the above-mentioned shape (the three-dimensional shape with no anisotropy as expressed in the above-mentioned circularity) with more ease. That is, if Tg of the resin (A) is too low, pores can get filled easily, so that it may become difficult to adjust the average pore size of the separator and the shape of the pores. Further, if Tg of the resin (A) is too high, the separator may harden and shrink during the production. Also in this case, it may become difficult to adjust the average pore size of the separator and the shape of the pores.

Tg of the resin (A) as used herein refers to a value obtained by measuring, with a differential scanning calorimeter (DSC) in accordance with JIS K 7121, Tg of a sheet (separator) containing the resin (A) obtained by a method described later in Examples.

It is preferable to use, together with the oligomer, a monomer polymerizable by irradiation with an energy ray to form the resin (A).

As will be describe later in detail, it is preferable that the separator including the resin (A) is produced through a process involving: preparing a separator forming composition containing an oligomer for forming the resin (A), a solvent, etc.; applying the separator forming composition to a substrate to form a coating; and irradiating the coating with an energy ray to form the resin (A). Here, by adding the monomer to the separator forming composition together with the oligomer, the viscosity of the separator forming composition can be adjusted with ease. Since this makes it easy to apply the composition to the substrate, the separator with more favorable properties can be achieved. Further, the crosslink density of the resin (A) can be easily adjusted with the use of the monomers, so that Tg of the resin (A) also can be adjusted with more ease.

Specific examples of the resin (A) include: an acrylic resin formed from an acrylic resin monomer [alkyl(meth)acrylate such as methyl methacrylate and methyl acrylate and a derivative thereof], an oligomer thereof, and a crosslinking agent; a crosslinked resin formed from urethane acrylate and a crosslinking agent; a crosslinked resin formed from epoxy acrylate and a crosslinking agent; and a crosslinked resin formed from polyester acrylate and a crosslinking agent. For any of the resins mentioned above, a bivalent or multivalent acrylic monomer (bi-, tri-, tetra-, penta-, or hexafunctional acrylate) such as tripropylene glycol diacrylate, 1,6-hexanediol diacrylate, tetraethylene glycol diacrylate, polyethylene glycol diacrylate, dioxane glycol diacrylate, tricyclodecane dimethanol diacrylate, dimethylol tricyclodecane acrylate, ethylene oxide modified trimethylolpropane triacrylate, dipentaerythritol pentaacrylate, caprolactone modified dipentaerythritol hexaacrylate, and e-caprolactone modified dipentaerythritol hexaacrylate can be used as the crosslinking agent.

Thus, when the resin (A) is the above-mentioned acrylic resin, for example, oligomers of the above examples of the acrylic resin monomer can be used as the oligomer polymerizable by irradiation with an energy ray (hereinafter simply referred to as the “oligomer”) and the above examples of the acrylic resin monomer and crosslinking agent can be used as the monomer polymerizable by irradiation with an energy ray (hereinafter simply referred to as the “monomer”).

Furthermore, when the resin (A) is the above-mentioned crosslinked resin formed from urethane acrylate and a crosslinking agent, urethane acrylate can be used as the oligomer and the above examples of the crosslinking agent and the like can be used as the monomer.

On the other hand, when the resin (A) is the above-mentioned crosslinked resin formed from epoxy acrylate and a crosslinking agent, epoxy acrylate can be used as the oligomer and the above examples of the crosslinking agent and the like can be used as the monomer.

Furthermore, when the resin (A) is the above-mentioned crosslinked resin formed from polyester acrylate and a crosslinking agent, polyester acrylate can be used as the oligomer and the above examples of the crosslinking agent and the like can be used as the monomer.

Further, to synthesize the resin (A), urethane acrylate, epoxy acrylate and polyester acrylate may be used in combination of two or more as the oligomers and bi-, tri-, tetra-, penta-, and hexafunctional acrylates described above may be used in combination of two or more as the crosslinking agent (monomers).

Further, a crosslinked resin derived from an unsaturated polyester resin that is made of a mixture of a styrene monomer and an ester composition produced by the condensation polymerization of a bivalent or multivalent alcohol and dicarboxylic acid;

and various polyurethane resins produced by reaction between polyisocyanate and polyol can also be used as the resin (A).

Thus, when the resin (A) is the above-mentioned crosslinked resin derived from an unsaturated polyester resin, the above-mentioned ester composition can be used as the oligomer and a styrene monomer can be used as the monomer.

When the resin (A) is any of various polyurethane resins produced by reaction between polyisocyanate and polyol, polyisocyanate may be, for example, hexamethylene diisocyanate, phenylene diisocyanate, toluene diisocyanate (IDA 4.4′-diphenylmethane diisocyanate isophorone diisocyanate (IPDI), or bis-(4-isocyanate cyclohexyl)methane and polyol may be, for example, polyether polyol, polycarbonate polyol, or polyester polyol.

Thus, when the resin (A) is any of various polyurethane resins that are produced by reaction between polyisocyanate and polyol, the above examples of polyol can be used as the oligomer and the above examples of polyisocyanate can be used as the monomer.

Further, when forming each of the above examples of the resin (A), a monofunctional monomer such as isobornyl acrylate, methoxy polyethylene glycol acrylate, and phenoxy polyethylene glycol acrylate can be used in combination. Thus, when the resin (A) includes a structural portion derived from any of these monofunctional monomers, the above examples of the monofunctional monomer can be used as the monomer together with the above examples of the other monomers and oligomers.

However, monofunctional monomers tend to remain in the resin (A) as unreactants after the formation of the resin (A), and the unreactants that remain in the resin (A) may leach out into the nonaqueous electrolyte of the nonaqueous electrolyte secondary battery, thereby impairing battery reactions. For this reason, the oligomer and the monomer used to form the resin (A) are preferably bifunctional or higher. Further, the oligomer and the monomer used to form the resin (A) are preferably hexafunctional or smaller.

When using the oligomer and the monomer in combination to form the resin (A), the mass ratio between the oligomer and the monomer used is preferably 20:80 to 95:5, and more preferably 65:35 to 90:10 in terms of making Tg more easily adjustable.

That is, when the oligomer and the monomer are used to form the resin (A), the mass ratio between the oligomer-derived unit and the monomer-derived unit of the resin (A) is preferably 20:80 to 95:5, and more preferably 65:35 to 90:10.

Although the separator of the present invention can be made only of the resin (A), inorganic particles (B) may be included in the separator together with the resin (A). The inclusion of the inorganic particles (B) in the separator allows further improvements in the strength and dimensional stability (especially dimensional stability against heat) of the separator.

Specific examples of the inorganic particles (B) include: particles of inorganic oxides such as iron oxide, silica (SiO₂), alumina (Al₂O₃), MgO (magnesium oxide), TiO₂ (titania), and BaTiO₃; particles of inorganic hydroxides such as aluminum hydroxide, and magnesium hydroxide; particles of inorganic nitrides such as aluminum nitride, and silicon nitride; particles of hardly soluble ionic crystals such as calcium fluoride, barium fluoride, and barium sulfate; particles of covalent crystals such as silicon and diamond; and fine particles of clays such as monmorillonite. Here, the inorganic oxide particles may be fine particles of materials derived from mineral resources such as boehmite, zeolite, apatite, kaolin, mullite, spinel, olivine, and mica, or artificial products thereof Further, the inorganic fine particles (B) may be electrically insulating particles obtained by coating, with a material having electrical insulation (e.g., any of the above inorganic oxides), the surface of a conductive material, exemplified by conductive oxides such as metal, SnO₂ and indium tin oxide (ITO) and carbonaceous materials such as carbon black and graphite. The above examples of the inorganic particles may be used alone or in combination of two or more. Among the above examples of inorganic particles, inorganic oxide particles and inorganic hydroxide particles are preferable, inorganic oxide particles are more preferable, and particles of alumina, titania, silica, and boehmite are even more preferable.

The average particle size of the inorganic particles (B) is preferably 0.001 μm or more, and more preferably 0.1 μm or more, and is preferably 15 μm or less, and more preferably 1 μm or less. Note that the average particle size of the inorganic particles (B) can be defined as a number average particle size measured by dispersing the inorganic particles (B) in a medium that does not dissolve the inorganic particles (B), for example, using a laser scattering particle size distribution analyzer (e.g., “LA-920” manufactured by Horiba, Ltd.) [the average particle size of the inorganic particles (B) in Examples (described later) were calculated by this method].

Further; the form of the inorganic particles (B) may be close to spherical or may be plate-like or fibrous, for example. However, in terms of improving the short circuit resistance of the separator, the inorganic particles (B) are preferably plate-like particles or particles having a secondary particle structure formed by agglomeration of primary particles. In particular, particles having a secondary particle structure formed by agglomeration of primary particles are more preferable in terms of improving the porosity of the separator. Typical examples of the plate-like particles and secondary particles include plate-like alumina and plate-like boehmite, alumina in the form of secondary particles, and boehmite in the form of secondary particles.

When including the inorganic particles (B) in the separator of the present invention, V_{A}/V_{B} as the ratio between the volume V_{A} of the resin (A) and the volume VB of the inorganic particles (B) is preferably 0.6 or more, and more preferably 3 or more. When V_{A}/V_{B} is in the range of above values, the occurrence of defects such as cracks can be suppressed more favorably by the effect of the highly flexible resin (A) even if the separator is bent to form a wound electrode group (especially a wound electrode group having a flat transverse section and used in rectangular cylindrical batteries and the like), for example. Thus, the short circuit resistance of the separator can be further improved.

Further, when including the inorganic particles (B) in the separator of the present invention, VA/VB is preferably 9 or less, and more preferably 8 or less. When VA/Vs is in the range of the above values, the effect of improving the separator strength and the effect of improving the dimensional stability of the separator resulting from the inclusion of the inorganic particles (B) can be achieved more favorably.

Furthermore, when including the inorganic particles (B) in the separator of the present invention, the separator preferably consists primarily of the resin (A) and the inorganic particles (B) when a porous base (described later) composed of a fibrous material (C) is not used. Specifically, the total volume (V_{A}+V_{B}) of the resin (A) and the inorganic particles (B) is preferably 50 vol % or more, and more preferably 70 vol % or more (also may be 100 vol %) of the entire volume (the volume excluding the pore portions: hereinafter, the same applies to the volume ratio of each component of the separator) of the components of the separator. On the other hand, when using the porous base (described later) composed of the fibrous material (C) in the separator of the present invention, the total volume (V_{A}+V_{B}) of the resin (A) and the inorganic particles (B) is preferably 20 vol % or more, and more preferably 40 vol % or more of the entire volume of the components of the separator.

Therefore, when including the inorganic particles (B) in the separator forming composition, it is desirable that the amount of the inorganic particles (B) to be added is adjusted such that VA/VB satisfies the above values and V_{A}+V_{B} satisfies the above values in the separator produced.

For example, when using the oligomer and the monomer to prepare the separator forming composition, the volume ratio between the total amount of the oligomer and the monomer and the amount of the inorganic particles is preferably 40:60 to 5:95.

Furthermore, the fibrous material (C) can also be included in the separator of the present invention. The inclusion of the fibrous material (C) also allows further improvements in the strength and the dimensional stability of the separator.

There is no particular limitation to the properties of the fibrous material (C) as long as the fibrous material (C) has a heat-resistant temperature (a temperature at which no deformation is observed by visual inspection) of 150° C. or higher, has electrical insulation, is electrochemically stable, and is stable against the nonaqueous electrolyte of a nonaqueous electrolyte secondary battery and solvents used in the production of the separator. The “fibrous material” as used herein has an aspect ratio (length in the longitudinal direction/width (diameter) in the direction perpendicular to the longitudinal direction) of 4 or more. The aspect ratio is preferably 10 or more.

Specific examples of constituents of the fibrous material (C) include: cellulose and its modified product (e.g., carboxymethyl cellulose (CMC) and hydroxypropyl cellulose WPM; resins such as polyolefin (e.g., polypropylene (PP) and a propylene copolymer), polyester (e.g., polyethylene terephthalate (PET), polyethylene naphthalate (PEN), and polybutylene terephthalate (PBT)), polyacrylonitrile (PAN), polyaramide, polyamide imide, and polyimide; and inorganic oxides such as glass, alumina, zirconia, and silica. Two or more of these constituents may be included. Further, the fibrous material (C) also may contain a variety of known additives (e.g., an antioxidant in the case of a resin fibrous material) as needed.

Further, the diameter of the fibrous material (C) may be less than or equal to the thickness of the separator, and is preferably 0.01 to 5 μm, for example. When the fiber diameter is too large, entanglement of the fibrous material becomes insufficient. Thus, when the fibrous material is used to form a sheet material as the base of the separator, the strength of the base is reduced, which may lead to deterioration of ease of handling. Further, when the diameter is too small, the pores of the separator become too small, which may reduce the effect of improving the lithium ion permeability.

The fibrous material (C) is present in the separator such that the angle between the surface of the separator and the major axis (i.e., the axis in the longitudinal direction) of the fibrous material (C) is, on average, preferably 30° or less, and more preferably 20° or less.

For example, the content of the fibrous material (C) in the separator is preferably 10 vol % or more, and more preferably 20 vol % or more of the entire components. Note that the content of the fibrous material (C) in the separator is preferably 70 vol % or less, and more preferably 60 vol % or less. However, when using the fibrous material (C) in the form of a porous base (described later), the content is preferably 90 vol % or less, and more preferably 80 vol % or less.

Thus, when including the fibrous material (C) in the separator forming composition, it is desirable to adjust the amount of the fibrous material (C) to be added or the amount of the separator forming composition to be applied to the surface of the porous base composed of the fibrous material (C) such that the content of the fibrous material (C) in the separator produced satisfies the above values.

Further, it is preferable that the separator of the present invention has the shutdown function in terms of further improving the level of safety of a nonaqueous electrolyte secondary battery for which the separator is used. To provide the separator with the shutdown function, for example, a thermoplastic resin having a melting point of 80° C. or higher and 140° C. or lower [hereinafter, referred to as the “heat-melting resin (D)”] or a resin that swells by absorbing a liquid nonaqueous electrolyte (a nonaqueous electrolyte, hereinafter, may simply be referred to as the “electrolyte”) when heated, and whose degree of swelling increases with an increase in the temperature (hereinafter, referred to as the “heat-swelling resin (E)”) may be included in the separator. In a separator that has been provided with the shutdown function by the above-described methods, when heat is generated in the nonaqueous electrolyte secondary battery, the heat-melting resin (D) melts and close the pores of the separator, or the heat-swelling resin (E) absorbs the nonaqueous electrolyte (liquid nonaqueous electrolyte) in the nonaqueous electrolyte secondary battery, causing a shutdown that suppresses the progress of electrochemical reactions.

To produce the separator containing the heat-melting resin (D) and/or the heat-swelling resin (E) by the method of the present invention, the heat-melting resin (D) and/or the heat-swelling resin (E) may be included in the separator forming composition.

The heat-melting resin (D) is preferably a resin that has a melting point, namely, a melting temperature measured with a DSC in accordance with JIS K 7121 of 80° C. or higher and 140° C. or lower, electrical insulation, and is stable against the nonaqueous electrolyte of a nonaqueous electrolyte secondary battery and solvents used in the production of the separator. Further, it is preferable that the resin is an electrochemically stable material that cannot be easily oxidized or reduced in the operating voltage range of the nonaqueous electrolyte secondary battery. Specific examples of the heat-melting resin (D) include polyethylene (PE), polypropylene (PP), copolymerized polyolefin, a polyolefin derivative (such as chlorinated polyethylene), a polyolefin wax, a petroleum wax, and a carnauba wax. Examples of the copolymerized polyolefin include a copolymer of ethylene-vinyl monomer, more specifically, an ethylene-propylene copolymer, EVA, and ethylene-acrylic acid copolymers such as an ethylene-methyl acrylate copolymer and an ethylene-ethyl acrylate copolymer. It is desirable that the ethylene-derived structural unit of the copolymerized polyolefin is 85 mol % or more. Further; it is also possible to use polycycloolefin and the like. The above examples of the heat-melting resin (D) may be used alone or in combination of two or more.

Among the materials described above as the examples of the heat-melting resin (D), PE, a polyolefin wax, PP, or EVA whose ethylene-derived structural unit is 85 mol % or more can be used preferably. Further, as needed, the heat-melting resin (D) also may contain a variety of known additives (e.g., an antioxidant) added to resins.

As the heat-swelling resin (E), usually, a resin can be used that absorbs no electrolyte or only a limited amount of electrolyte in a temperature range (about 70° C. or lower) in which batteries are used, and therefore has a degree of swelling lower than or equal to a prescribed degree, but when heated to a required temperature (Tc), significantly swells by absorbing an electrolyte and whose degree of swelling increases with an increase in the temperature. In a nonaqueous electrolyte secondary battery using a separator containing the heat-swelling resin (E), flowable electrolyte that is not absorbed by the heat-swelling resin (E) is present in the pores of the separator at temperatures lower than Tc, and therefore the lithium ion conductivity inside the separator increases, making it possible to achieve a nonaqueous electrolyte secondary battery with favorable load characteristics. On the other hand, when heated to a temperature higher than or equal to the temperature at which the property that the degree of swelling increases with an increase in the temperature (hereinafter, may be referred to as the “heat-swelling property”) is exhibited, the heat-swelling resin (E) significantly swells by absorbing the electrolyte contained in the battery, and the swelled heat-swelling resin (E) closes the pores of the separator, and at the same time, the amount of flowable electrolyte decreases, leading to electrolyte deficiency in the nonaqueous electrolyte secondary battery. This suppresses the reaction between the electrolyte and the active materials, thus further improving the level of safety of the nonaqueous electrolyte secondary battery. Moreover, if the temperature is elevated and becomes higher than Tc, the above-mentioned electrolyte deficiency advances further by the heat-swelling property to suppress the battery reaction even further, which in return makes it possible to further improve the level of safety at elevated temperatures.

The temperature at which the heat-swelling resin (E) starts to exhibit the heat-swelling property is preferably 75° C. or higher. This is because, by setting the temperature at which the heat-swelling resin (E) starts to exhibit the heat-swelling property to 75° C. or higher, the temperature (Tc) at which the internal resistance of the battery increases due to a significant decrease in the Li ion conductivity can be set to about 80° C. or higher. On the other hand, the higher the lower limit to the temperature at which the heat-swelling property is exhibited, the higher Tc of the separator becomes. Therefore, in order to set Tc to about 130° C. or lower, the temperature at which the heat-swelling resin (E) starts to exhibit the heat-swelling property is preferably 125° C. or lower, and more preferably 115° C. or lower. If the temperature at which the heat-swelling property is exhibited is too high, the effect of improving the level of safety of the nonaqueous electrolyte secondary battery may not be ensured sufficiently because the thermal runaway reaction of the active materials inside the battery cannot be suppressed adequately. Further, if the temperature at which the heat-swelling property is exhibited is too low, the lithium ion conductivity may be reduced excessively in a normal working temperature range (about 70° C. or lower) of the nonaqueous electrolyte secondary battery.

Further, it is desirable that the heat-swelling resin (E) absorbs electrolyte as little as possible and undergoes little swelling at a temperature lower than the temperature at which the heat-swelling property is exhibited. This is because the nonaqueous electrolyte secondary battery exhibits more favorable characteristics such as load characteristics in the working temperature range of the nonaqueous electrolyte secondary battery, for example, at ambient temperature if the electrolyte is retained in a flowable state in the pores of the separator than when it is incorporated into the heat-swelling resin (E).

Although the form of the heat-melting resin (D) and the heat-swelling resin (E) [hereinafter, the heat-melting resin (D) and the heat-swelling resin (E) may be collectively referred to as a “shutdown resin”] is not particularly limited, it is preferable to use them in the form of fine particles. It is sufficient that the particle size of the fine particles in a dry state is smaller than the thickness of the separator, and their average particle size is preferably 1/100 to ⅓ of the thickness of the separator. Specifically, the average particle size is preferably 0.1 to 20 μm. When the particle size of the shutdown resin particles is too small, the gap between the particles is excessively reduced and the ion conduction path is increased, which may degrade the characteristics of the nonaqueous electrolyte secondary battery. Further, when the particle size of the shutdown resin particles is too large, the gap is increased, which may reduce the effect of improving the resistance to short circuit caused by lithium dendrites and the like. Note that the average particle size of the shutdown resin particles can be defined as a number average particle size, measured using, for example, a laser diffraction particle size analyzer (e.g., “LA-920” manufactured by Horiba, Ltd.) by dispersing the fine particles in a medium (e.g., water) that does not cause swelling of the shutdown resin.

The shutdown resin may be in a different form from the one above described, and may be present in a state in which it is deposited on the surface of any of the other components including, for example, the inorganic particles or the fibrous material and thus integrated with the constituent. Specifically, the shutdown resin may be present as particles having a core-shell structure in which the inorganic particles serve as the core and the shutdown resin serves as the shell. Alternatively, the shutdown resin may be present in the form of fibers having a multilayered structure including the shutdown resin on the surface of a core material.

To achieve the shutdown effect more easily, the content of the shutdown resin in the separator is, for example, preferably as follows. The volume of the shutdown resin is preferably 10 vol % or more, and more preferably 20 vol % or more of the entire volume of the components of the separator. On the other hand, in terms of ensuring the shape stability of the separator at elevated temperatures, the volume of the shutdown resin is preferably 50 vol % or less, and more preferably 40 vol % or less of the entire volume of the components of the separator.

The separator of the present invention is composed of a single porous layer including the resin (A), and optionally the inorganic particles (B), the fibrous material (C), the shutdown resin and the like, and may be present in the form of an independent film. In addition to this, the porous layer may be integral with electrodes (positive and negative electrodes) of the nonaqueous electrolyte secondary battery or with a porous base (described later in detail).

For example, the separator of the present invention can be produced by the method of the present invention, which includes the steps of (1) applying to a substrate a separator forming composition at least containing the oligomer and a solvent; (2) irradiating with an energy ray a coating of the separator forming composition applied to the substrate to form the resin (A) having a crosslinked structure; and (3) drying the energy ray-irradiated coating of the separator forming composition to form pores.

As the separator forming composition, a composition (e.g., slurry) that includes the oligomer, the monomer, and a polymerization initiator, as well as components to be included in the separator as needed such as the inorganic particles (B), the fibrous material (C), and particles of the shutdown resin is used, and the composition is obtained by dispersing these components in a solvent.

For the separator forming composition, it is preferable to use two or more kinds of solvents having different polarity from each other.

Thus, for the separator forming composition, it is preferable to use a combination of a solvent (a), which is more compatible with the oligomer and the monomer, and a solvent (b), which is less compatible with the resin (A) formed in the step (2) than the solvent (a). In this case, since the solvent (a) can favorably dissolve the oligomer and the monomer, a coating formed by applying the separator forming composition to the substrate becomes favorably uniform, which in turn improves the uniformity of the separator. On the other hand, the solvent (b) is dispersed in the coating as fine droplets after the formation of the resin (A). Thus, when the solvent (b) is removed together with the solvent (a) by drying in the subsequent step (3), a number of fine and uniform pores are formed in the separator. Consequently, in the separator produced by the method of the present invention using a combination of two or more kinds of solvents having different polarity from each other, a number of pores having the shape and the average pore size as described are formed. Further, the separator has the above-described air permeability, excellent lithium ion permeability and excellent short-circuit resistance during the charging of the nonaqueous electrolyte secondary battery.

Specifically, the solubility parameter (hereinafter referred to as the “SP value”) of the solvent (a) is different from that of the oligomer for forming the resin (A) by preferably ±1.5 or less, and more preferably ±1.0 or less. That is, the smaller the difference between the SP value of the solvent (a) and that of the oligomer, the more favorable the compatibility between the solvent (a) and the oligomer becomes. Further, when using the monomer in combination with the oligomer to form the resin (A), the SP value of the solvent (a) is different from that of the monomer by even more preferably ±1.5 or less, and particularly preferably ±1.0 or less.

Further, the SP value of the resin (A) will be close to that of the oligomer (and further that of the monomer) used to form the resin (A). Thus, the SP value of the solvent (b) is different from that of the oligomer by preferably ±1.55 or more, and more preferably ±2.0 or more. Further, when using the monomer in combination with the oligomer to form the resin (A), the SP value of the solvent (b) is different from that of the monomer by even more preferably +1.55 or more, and particularly preferably ±2.0 or more. However, if the difference between the SP value of the solvent (b) and those of the oligomer and the monomer used to form the resin (A) is too large, the separator forming composition may become easily layered and thus uneven. Therefore, the SP value of the solvent (b) is different from that of the oligomer used to form the resin (A) by preferably ±15 or less, and more preferably ±10.0 or less. Further, when using the monomer in combination with the oligomer to form the resin (A), the SP value of the solvent (b) is different from that of the monomer by even more preferably ±15 or less, and particularly preferably ±10.0 or less.

For the solvent (a), it is preferable to use one having an SP value of 8.9 or more and 9.9 or less.

Specific examples of the solvent (a) include: toluene (SP value: 8.9), butyraldehyde (SP value: 9.0), ethyl acetate (SP value: 9.0), ethyl acetate (SP value: 9.1), tetrahydrofuran (SP value: 9.1), benzene (SP value: 9.2), methyl ethyl ketone (SP value: 9.3), benzaldehyde (SP value: 9.4), chlorobenzen (SP value: 9.5), ethylene glycol monobutyl ether (SP value: 9.5), 2-ethyl hexanol (SP value: 9.5), methyl acetate (SP value: 9.6), dichloroethyl ether (SP value: 9.8), 1,2-dichloroethane (SP value: 9.8), acetone (SP value: 9.8), and cyclohexanon (SP value: 9.9).

For the solvent (b), it is preferable to use one having an SP value of 7 or more and 8 or less [hereinafter referred to as the solvent (b-1)] or one having an SP value of larger than 10 and 15 or less [hereinafter referred to as the solvent (b-2)].

Specific examples of the solvent (b-1) include: 1-nitro octane (SP value: 7.0), pentane (SP value: 7.0), diethyl ether (SP value: 7.4), octane (SP value: 7.6), isoamyl acetate (SP value: 7.8), diisobutyl ketone (SP value: 7.8), methyl decanoate (SP value: 8.0), and diethylamine (SP value: 8.0).

When using the solvent (a) and the solvent (b-1) in combination for the separator forming composition, Vₛₐ/V_{sb} as the ratio between the volume Vₛₐ of the solvent (a) and the volume V_{sb} of the solvent (b-1) is preferably 0.05 to 0.7.

Specific examples of the solvent (b-2) include: acetic acid (SP value: 10.1), m-cresol (SP value: 10.2), aniline (SP value: 10.3), i-octanol (SP value: 10.3), cyclopentanone (SP value: 10.4), ethylene glycol monoethyl ether (SP value: 10.5), t-butyl alcohol (SP value: 10.6), pyridine (SP value: 10.7), propyronitryl (SP value: 10.8), N,N-dimethyl acetamide (SP value: 10.8), 1-pentanol (SP value: 10.9), nitroethane (SP value: 11.1), furfural (SP value: 11.2), 1-butanol (SP value: 11.4), cyclohexanol (SP value: 11.4), isopropanol (SP value: 11.5), acetonitrile (SP value: 11.9), N,N-dimethyl formamide (SP value: 11.9), benzyl alcohol (SP value: 12.1), diethylene glycol (SP value: 12.1), ethanol (SP value: 12.7), dimethyl sulfoxide (SP value: 12.9), 1,2-propylene carbon acid (SP value: 13.3), N-ethyl formamide (SP value: 13.9), ethyelene glycol (SP value: 14.1), and methanol (SP value: 14.5).

When using the solvent (a) and the solvent (b-2) in combination for the separator forming composition, V_{sc}Vₛₐ as the ratio between the volume Vₛₐ of the solvent (a) and the volume V_{sc} of the solvent (b-2) is preferably 0.04 to 0.2.

When using the solvent (a) and the solvent (b) in combination for the separator forming composition, it is preferable to choose as the solvent (b) one having a higher boiling point than that of the solvent (a). In this case, pores formed in the separator become more fine and uniform.

The SP value of the oligomer and that of the monomer can be determined by summing the SP values of respective structural parts (functional groups) of the oligomer or the monomer, given that the additivity stands. For example, a variety of documents provide the SP value of each structural part.

Generally, an energy ray-sensitive polymerization initiator is included in the separator forming composition. Specific examples of the polymerization initiator includes bis(2,4,6-trimethylbenzoyl)-phenylphosphine oxide, 2,2-dimethoxy-2-phenylacetophenone, and 2-hydroxy-2-methylpropiophenone. The amount of the polymerization initiator used is preferably 1 to 10 parts by mass with respect to 100 parts by mass of the total amount of the oligomer and the monomer (in the case of using the oligomer alone, the amount thereof).

The solid content of the separator forming composition including the oligomer, the monomer, the polymerization initiator, and optionally the inorganic particles (B) and the like is preferably, for example, 10 to 50 mass %.

For example, an electrode for a nonaqueous electrolyte secondary battery (a positive electrode or a negative electrode), a porous base, a base such as a film or metal foil can be used as the substrate to which the separator forming composition is applied.

When using an electrode for a nonaqueous electrolyte secondary battery as the substrate, it is possible to produce the separator integral with the electrode. Further, when using a porous base as the substrate, it is possible to produce the separator having a multilayer structure composed of the porous base and a layer made from the separator forming composition. Furthermore, when using a base such as a film or metal foil as the substrate, it is possible to produce the separator in the form of an independent film by separating the produced separator from the base.

Examples of the porous base used as the substrate include porous sheets such as a woven fabric made of at least one type of fibrous material including any of the exemplary materials described above as a component, and a nonwoven fabric having a structure in which the fibrous material is entangled. More specifically, examples thereof include paper, a PP nonwoven fabric, polyester nonwoven fabrics (e.g., a PET nonwoven fabric, a PEN nonwoven fabric, and a PBT nonwoven fabric), and a PAN nonwoven fabric.

Further, microporous films (e.g., microporous films made of polyolefin such as PE and PP) generally used as separators for nonaqueous electrolyte secondary batteries also can be used as the porous base. The use of such a porous base can also provide the separator with the shutdown function. Note that such a porous base generally has low heat resistance, so that it may shrink as the internal temperature of a nonaqueous electrolyte secondary battery increases. This may lead to short circuit due to contact between the positive electrode and the negative electrode. However, in the case of the separator produced by the method of the present invention, a layer containing the resin (A) having excellent heat resistance is formed on the surface of such a porous base, and this layer can suppress the thermal shrinkage of the porous base. Accordingly, a nonaqueous electrolyte secondary battery with an excellent level of safety can be formed with the separator.

To apply the separator forming composition to the substrate, a variety of known application methods can be adopted. Further, when using an electrode for a nonaqueous electrolyte secondary battery or a porous base as the substrate, these substrates may be impregnated with the separator forming composition.

In the step (2) of the method of the present invention, a coating of the separator forming composition applied to the substrate is irradiated with an energy ray to form the resin (A).

Examples of the energy ray with which a coating of the separator forming composition is irradiated include visible light, ultraviolet rays, radiation, and electron beams. It is more preferable to use visible light or ultraviolet rays because they are safer to use.

It is preferable to appropriately adjust the conditions for energy ray irradiation, such as the wavelength, the irradiation strength, and the irradiation time, so that the resin (A) can be formed favorably. Specifically, the wavelength of the energy ray can be set to 320 to 390 nm, and the irradiation strength can be set to 623 to 1081 mJ/cm². Note, however, that the conditions for energy ray irradiation are not limited to those described above.

In the step (3) of the method of the present invention, the solvent(s) is removed from the energy ray-irradiated coating of the separator forming composition to form pores. The drying conditions (e.g., temperature, time, drying method) may be appropriately selected in accordance with the type of the solvent(s) used for the separator forming composition such that the solvent(s) can be removed favorably. Specifically, the drying temperature can be set to 20 to 80° C., and the drying time can be set to 30 minutes to 24 hours. In addition to air drying, it is possible to use, as the drying method, a method using a thermostatic oven, a dryer, a hot plate (in the case of directly forming the separator on the electrode surface), or the like. Note, however, that the drying conditions in the step (3) are not limited to those described above.

When using a base such as a film or metal foil as the substrate, the separator formed through the step (3) is separated from the substrate and is used for the production of a nonaqueous electrolyte secondary battery, as described above. On the other hand, when using an electrode or a porous base as the substrate, the separator (or layer) formed may be used for the production of a nonaqueous electrolyte secondary battery without separating the separator (or layer) from the substrate.

Alternatively, the separator may be provided with the shutdown resin by forming a layer containing the above-described shutdown resin (e.g., a layer composed solely of the shutdown resin, a layer containing the shutdown resin and a binder, etc.) on one side or both sides of the separator produced.

It is also possible to adopt methods other than the method of the present invention to produce the separator of the present invention. For example, the separator of the present invention can be produced by implementing the above-described steps (1) and (2) where the separator forming composition including a material dissolvable in a certain solvent (a solvent other than those used for the separator forming composition) is used, drying the applied composition as needed, and then extracting the material using the certain solvent to form pores.

As the material dissolvable in the certain solvent, a polyolefin resin, a polyurethane resin, an acrylic resin, or the like can be used, for example. It is preferable to use these materials in the form of particles, and the size and the amount to be used can be adjusted in accordance with, for example, the porosity and the pore size required of the separator. Generally, the average particle size of the material [average particle size measured by the same method as one used to measure the average particle size of the inorganic particles (B)] is preferably 0.1 to 20 μm, and the amount to be used is preferably 1 to 10 mass % of the total solid content of the separator forming composition.

In order to ensure the amount of electrolyte retained and to achieve good lithium ion permeability, the porosity of the separator of the present invention is preferably 10% or more in a dry state. On the other hand, in terms of ensuring the separator strength and preventing internal short circuit, the porosity of the separator is preferably 70% or less in a dry state. The porosity: P (%) of the separator in a dry state can be calculated by obtaining the total sum of components i using Formula (1) below from the thickness and the mass per area of the separator, and the density of the separator components.

P={1−(m/t)/Σaᵢ·ρᵢ)}×100 (1)

Where, aᵢ is the ratio of component i, taking the mass of the whole as 1, ρᵢ is the density of the component i (g/cm³), m is the mass per unit area of the separator (g/cm²), and t is the thickness (cm) of the separator.

Furthermore, it is desirable that the separator of the present invention has a strength of 50 g or more, the strength being a penetrating strength obtained using a needle having a diameter of 1 mm. When the penetrating strength is too small, short-circuiting may occur as a result of the separator being penetrated by lithium dendrites when the dendrites are formed. By adopting the above-described configuration, the separator can have the above penetrating strength.

In terms of separating the positive electrode and the negative electrode with more certainty, the thickness of the separator of the present invention is preferably 6 pm or more, and more preferably 10 μm or more. On the other hand, when the thickness of the separator is too large, the energy density of a battery using the separator may decline. Therefore, the thickness is preferably 50 μm or less, and more preferably 30 μm or less.

As long as the nonaqueous electrolyte secondary battery of the present invention includes a positive electrode, a negative electrode, a separator, and a nonaqueous electrolyte and the separator is the separator of the present invention, there is no particular limitation to the rest of the configuration and structure, and any of various conventionally known configurations and structures adopted in nonaqueous electrolyte secondary batteries can be used.

The form of the nonaqueous electrolyte secondary battery may be cylindrical (e.g., rectangular cylindrical, circular cylindrical) using a steel can, an aluminum can or the like as an outer can. Further, the nonaqueous electrolyte secondary battery may be in the form of a soft package battery using a metal-evaporated laminate film as an outer package.

There is no particular limitation to the positive electrode, as long as it is a positive electrode used for conventionally known nonaqueous electrolyte secondary batteries, i.e., a positive electrode containing an active material capable of intercalating and deintercalating Li ions. Examples of usable active materials include: lithium-containing transition metal oxides having a layered structure represented by Li₁₊ₓMO₂ (−0.1<x<0.1, and M:Co, Ni, Mn, Al, Mg, etc.); lithium manganese oxides having a spinel structure such as LiMn₂O₄ and those obtained by partially replacing any of the elements of LiMn₂O₄ with another element; and olivine-type compounds represented by LiMPO₄ (M: Co, Ni, Mn, Fe, etc.). Specific examples of the lithium-containing transition metal oxides having a layered structure include, in addition to LiCoO₂ and LiNi₁₋ₓCo_{x-y}Al_{y}O₂ (0.1≦x≦0.3, 0.01≦y≦0.2), oxides containing at least Co, Ni and Mn (LiMn_{1/3}Ni_{1/3}Co_{1/3}O₂, LiMn_{5/12}Ni_{5/12}Co_{1/6}O₂, LiMn_{3/5}Ni_{1/5}Co_{1/5}O₂, etc.).

A carbon material such as carbon black can be used as a conductive assistant, and a fluororesin such as PVDF can be used as a binder. Using a positive electrode mixture in which these materials are mixed with the active material, a positive electrode active material-containing layer is formed, for example, on a current collector.

For example, a foil, a punched metal, a mesh, and an expanded metal made of metal such as aluminum can be used as a positive electrode current collector. Generally, an aluminum foil having a thickness of 10 to 30 μm is used preferably.

Generally, a positive electrode lead portion is provided in the following manner. At the time of the production of the positive electrode, the positive electrode active material-containing layer is not formed on a part of the current collector to leave it exposed, and this exposed portion serves as the lead portion. Note that there is no need for the lead portion to be integral with the current collector from the beginning, and may be provided by connecting an aluminum foil or the like to the current collector afterwards.

There is no particular limitation to the negative electrode, as long as it is a negative electrode used for conventionally known nonaqueous electrolyte secondary batteries, i.e., a negative electrode containing an active material capable of intercalating and deintercalating Li ions. As the active material, carbon-based materials capable of intercalating and deintercalating lithium, such as graphite, pyrolytic carbons, cokes, glassy carbons, calcinated organic polymer compounds, mesocarbon microbeads (MCMB) and carbon fibers can be used alone or in combination of two or more. It is also possible to use Si, and a compound capable of being charged and discharged at a low voltage close to that of a lithium metal such as an S compound, or a lithium metal, and a lithium/aluminum alloy as a negative electrode active material. The negative electrode may be produced in such a manner that a negative electrode mixture is obtained by adding a conductive assistant (e.g., a carbon material such as carbon black) and a binder such as PVDF appropriately to the negative electrode active material, and then formed into a compact (a negative electrode active material-containing layer), with a current collector used as a core material. Alternatively, foils of the lithium metal or various alloys as described above can be used alone or in the form of a laminate with the current collector as the negative electrode.

When using a current collector for the negative electrode, a foil, a punched metal, a mesh, an expanded metal made of copper or nickel, and the like can be used. Generally, a copper foil is used as the current collector. When the thickness of the negative electrode as a whole is reduced to obtain a high energy density battery, an upper limit to the thickness of the negative electrode current collector is preferably 30 pm and a lower limit is desirably 5 μm. A negative electrode lead portion can be formed in the same manner as the positive electrode lead portion.

The positive electrode and the negative electrode as described above can be used in the form of a laminated electrode group obtained by laminating these electrodes through the separator of the present invention, or in the form of a wound electrode group obtained by further winding the laminated electrode group. Additionally, due to the effect of the highly flexible resin (A), the separator of the present invention also exhibits excellent short circuit resistance when bent. Thus, in the nonaqueous electrolyte secondary battery of the present invention using the separator of the present invention, this effect becomes more prominent in the case of using a wound electrode group that requires changing the shape of the separator. The effect becomes particularly prominent in the case of using a flat wound electrode group (wound electrode group having a flat transverse section) that requires bending the separator with a strong force.

A solution (nonaqueous electrolyte) obtained by dissolving a lithium salt in an organic solvent is used as the nonaqueous electrolyte. There is no particular limitation to the lithium salt as long as it can dissociate in the solvent into Li⁺ ion and is less likely to cause side reactions such as decomposition in a voltage range where batteries are used. Examples of usable lithium salts include inorganic lithium salts such as LiClO₄, LiPF₆, LiBF₄, LiAsF₆, and LiSbF₆, and organic lithium salts such as LiCF₃SO_{3,} LiCF₃CO₂, Li₂C₂F₄(SO₃)₂, LiN(CF₃SO₂)₂, LiC(CF₃SO₂)₃, LiCₙF₂ₙ₊₁SO₃ (n≧2), and LiN(RfOSO₂)₂ (where Rf is a fluoroalkyl group).

There is no particular limitation to the organic solvent used for the nonaqueous electrolyte as long as the organic solvent dissolves the above-listed lithium salts and does not cause side reactions such as decomposition in a voltage range where batteries are used. Examples of the organic solvent include: cyclic carbonates such as ethylene carbonate, propylene carbonate, butylene carbonate, and vinylene carbonate; chain carbonates such as dimethyl carbonate, diethyl carbonate, and methyl ethyl carbonate; chain esters such as methyl propionate; cyclic esters such as y-butyrolactone; chain ethers such as dimethoxyethane, diethyl ether, 1,3-dioxolane, diglyme, triglyme, and tetraglyme; cyclic ethers such as dioxane, tetrahydrofuran, and 2-methyltetrahydrofuran; nitriles such as acetonitrile, propionitrile, and methoxy propionitrile; and sulfite esters such as ethylene glycol sulfite, and they can be used in combination of two or more. To achieve a battery with more favorable characteristics, it is desirable to use a combination of the above organic solvents from which high conductivity can be achieved, such as a mixed solvent of an ethylene carbonate and a chain carbonate. Further, for the purpose of improving the characteristics of the battery such as the level of safety, charge-discharge cycle characteristics and high-temperature storability, additives such as vinylene carbonates, 1,3-propane sultone, diphenyl disulfide, cyclohexane, biphenyl, fluorobenzene, and t-butyl benzene can be added to the nonaqueous electrolyte as needed.

The concentration of the lithium salt in the nonaqueous electrolyte is preferably 0.5 to 1.5 mol/L, and more preferably 0.9 to 1.3 mol/L.

The above-described nonaqueous electrolyte may also be used in the form of a gel (gel electrolyte) by adding a known gelling agent such as a polymer to the nonaqueous electrolyte.

### EXAMPLES

Hereinafter, the present invention will be described in detail by way of Examples. Note that the present invention is not limited to Examples described below.

### Example 1

### <Preparation of Separator Forming Slurry>

To 80 parts by mass of urethane acrylate (“EBECRYL 284” manufactured by DAICEL-CYTEC Company LTD.) as the oligomer, 20 parts by mass of tripropylene glycol diacrylate as the monomer, 2 part by mass of bis(2,4,6-trimethylbenzoyl)-phenylphosphine oxide as a photoinitiator, 300 parts by mass of boehmite (average particle size: 1 μm) as the inorganic fine particles (B), and 600 parts by mass of a mixed solvent of methyl ethyl ketone as the solvent (a) and ethylene glycol as the solvent (c) at a volume ratio of 9:1, zirconia beads having a diameter of 1 mm were added in an amount as 5 times (on a mass basis) as large as that of boehmite. They were stirred uniformly for 15 hours using a ball mill and then were filtrated to prepare a separator forming slurry

### <Production of Negative Electrode>

95 parts by mass of graphite as the negative electrode active material and 5 parts by mass of PVDF were mixed with each other uniformly in N-methyl-2-pyrrolidone (NMP) as a solvent to prepare a negative electrode mixture-containing paste. This paste was applied intermittently onto both sides of a 10-μm thick copper foil current collector such that the application length was 290 mm on the front side and 230 mm on the backside, followed by drying. Then, calendering was performed so as to adjust the total thickness of the negative electrode active material-containing layers to 142 μm, and cutting was performed so as to bring the width thereof to 45 mm. Thus, a negative electrode was produced. Thereafter, a tab was attached to an exposed portion of the copper foil of the negative electrode.

### <Production of Separator-Negative Electrode Composite>

The separator forming slurry was applied to both sides of the negative electrode, and the applied slurry was irradiated with ultraviolet rays with a wavelength of 365 nm for 10 seconds at intensity of 1000 mW/cm², followed by drying at 60° C. for 1 hour, thus forming a 20 μm-thick separator on both sides of the negative electrode. V_{A}/V_{B} as the ratio between the volume V_{A} of the resin (A) and the volume V_{B} of the inorganic particles (B) in the separator was 0.8.

### <Production of Positive Electrode>

90 parts by mass of LiCoO₂ as the positive electrode active material, 7 parts by mass of acetylene black as a conductive assistant, and 3 parts by mass of PVDF as a binder were mixed with each other uniformly in NMP as a solvent to prepare a positive electrode mixture-containing paste. This paste was applied intermittently onto both sides of a 15-μm thick aluminum foil current collector such that the application length was 280 mm on the front side and 210 mm on the backside, followed by drying. Then, calendering was performed so as to adjust the total thickness of the positive electrode active material-containing layers to 150 μm, and cutting was performed so as to bring the width thereof to 43 mm. Thus, a positive electrode was produced. Thereafter, a tab was attached to an exposed portion of the aluminum foil of the positive electrode.

<Assembly of Battery>

The separator-negative electrode composite and the positive electrode were stacked together, and wound in a spiral fashion to produce a wound electrode group.

The wound electrode group obtained was pressed into a flat shape, and then was placed in an aluminum outer can having a thickness of 4 mm, a height of 50 mm, and a width of 34 mm. An electrolyte (obtained by dissolving LiPF₆ at a concentration of 1.2 mol/L in a mixed solvent of ethylene carbonate and ethyl methyl carbonate at a volume ratio of 1:2) was injected into the outer can, and then the outer can was sealed.

Thus, a rectangular nonaqueous electrolyte secondary battery having the structure as shown in FIG. 1 and the external appearance as shown in FIG. 2 was produced.

Here, FIGS. 1 and 2 will be described. FIG. 1(a) is a plan view of the nonaqueous electrolyte secondary battery, and FIG. 1(b) is a partial longitudinal sectional view of the battery. A positive electrode 1 and a negative electrode 2 are housed in a rectangular outer can 4 together with a nonaqueous electrolyte as a wound electrode group 6, which has been wound in a spiral fashion through a separator 3 as described above. However, in order to simplify the illustrations of FIG. 1, the metal foils as current collectors and the electrolyte used to produce the positive electrode 1 and the negative electrode 2 are not illustrated.

The outer can 4 is made of aluminum alloy, and constitutes an outer package of the battery. The outer can 4 also serves as a positive electrode terminal. An insulator 5 made of a polyethylene sheet is placed on the bottom of the outer can 4, and a positive electrode current collector plate 7 and a negative electrode current collector plate 8 connected to the ends of the positive electrode 1 and the negative electrode 2, respectively, are drawn from the electrode group 6 composed of the positive electrode 1, the negative electrode 2, and the separator 3. A stainless steel terminal 11 is attached to a cover plate 9 made of aluminum alloy for sealing the opening of the outer can 4 through a polypropylene insulating packing 10, and a stainless steel lead plate (electrode terminal current collecting mechanism) 13 is attached to the terminal 11 through an insulator 12.

The cover plate 9 is inserted in the opening of the outer can 4. By welding the junction of the cover plate 9 and the opening, the opening of the outer can 4 is sealed and thus the inside of the battery is hermetically sealed.

In addition, the cover plate 9 is provided with an injection opening (denoted by Numeral 14 in the drawings). The electrolyte is injected into the battery through the injection opening during the assembly of the battery, and then the injection opening is sealed. Further, the cover plate 9 is provided with a safety valve 15 for preventing explosion.

In the battery of Example 1, the outer can 4 and the cover plate 9 function as a positive electrode terminal by welding the positive electrode current collector plate 7 directly to the cover plate 9, and the terminal 11 functions as a negative electrode terminal by welding the negative electrode current collector plate 8 to a lead plate 13 and conducting the negative electrode current collector plate 8 and the terminal 11 through the lead plate 13. However, depending on the material, etc., of the outer can 4, the positive and the negative may be reversed.

FIG. 2 is a perspective view schematically showing the external appearance of the battery shown in FIG. 1. FIG. 2 is illustrated to indicate that the battery is a rectangular battery. In FIG. 2, the battery is schematically shown and only specific components of the battery are illustrated. Similarly, in FIG. 1, the inner circumferential side of the electrode group is not hatched.

### Example 2

A separator forming slurry was prepared in the same manner as in Example 1 except that urethane acrylate “EBECRYL 8402” manufactured by DAICEL-CYTEC Company LTD., was used as the oligomer, 1,6-hexanediol diacrylate was used as the monomer, and boehmite having an average particle size of 0.7 μm was used. Except for using this separator forming slurry, a separator-negative electrode composite was produced in the same manner as in Example 1. V_{A}/V_{B} as the ratio between the volume V_{A} of the resin (A) and the volume V_{B} of the inorganic particles (B) in the separator was 0.8.

And except for using the separator-negative electrode composite obtained above, a nonaqueous electrolyte secondary battery was produced in the same manner as in Example 1.

### Example 3

A separator forming slurry was prepared in the same manner as in Example 1 except that urethane acrylate “EBECRYL 8402” manufactured by DAICEL-CYTEC Company LTD., was used as the oligomer, and polyethylene glycol diacrylate was used as the monomer. Except for using this separator forming slurry, a separator-negative electrode composite was produced in the same manner as in Example 1. V_{A}/V_{B} as the ratio between the volume V_{A} of the resin (A) and the volume V_{B} of the inorganic particles (B) in the separator was 0.8.

And except for using the separator-negative electrode composite obtained above, a nonaqueous electrolyte secondary battery was produced in the same manner as in Example 1.

### Comparative Example 1

100 parts by mass of dipentaerythritol pentaacrylate as the monomer, 1 part by mass of bis(2,4,6-trimethylbenzoyl)-phenylphosphine oxide as a photoinitiator, 200 parts by mass of alumina (average particle size: 0.4 μm) as the inorganic particles (B) were mixed with each other uniformly, and then were filtered to prepare a separator forming slurry. And except for using this separator forming slurry, a separator-negative electrode composite was produced in the same manner as in Example 1. V_{A}/V_{B} as the ratio between the volume V_{A} of the crosslinked resin and the volume V_{B} of the inorganic particles (B) in the separator was 1.3.

Furthermore, except for using the separator-negative electrode composite obtained above, a nonaqueous electrolyte secondary battery was produced in the same manner as in Example 1.

### Comparative Example 2

A separator forming slurry was prepared in the same manner as in Example 2 except that no oligomer was used and 100 parts by mass of dipentaerythritol pentaacrylate was used as the monomer. Except for using this separator forming slurry, a separator-negative electrode composite was produced in the same manner as in Example 1. V_{A}/V_{B} as the ratio between the volume V_{A} of the crosslinked resin and the volume V_{B} of the inorganic particles (B) in the separator was 0.8.

And except for using the separator-negative electrode composite obtained above, a nonaqueous electrolyte secondary battery was produced in the same manner as in Example 1.

### Comparative Example 3

A separator forming slurry was prepared in the same manner as in Example 2 except that no oligomer was used and 100 parts by mass of polyethylene glycol diacrylate was used as the monomer. Except for using this separator forming slurry, a separator-negative electrode composite was produced in the same manner as in Example 1. V_{A}/V_{B} as the ratio between the volume V_{A} of the crosslinked resin and the volume V_{B} of the inorganic particles (B) in the separator was 0.8.

And except for using the separator-negative electrode composite obtained above, a nonaqueous electrolyte secondary battery was produced in the same manner as in Example 1.

### Comparative Example 4

A separator forming slurry was prepared in the same manner as in Example 2 except that 600 parts by mass of methyl ethyl ketone was used as the solvent for the separator forming composition. Except for using this separator forming slurry, a separator-negative electrode composite was produced in the same manner as in Example 1. V_{A}/V_{B} as the ratio between the volume V_{A} of the crosslinked resin and the volume V_{B} of the inorganic particles (B) in the separator was 0.8.

And except for using the separator-negative electrode composite obtained above, a nonaqueous electrolyte secondary battery was produced in the same manner as in Example 1.

### Comparative Example 5

An attempt was made to prepare a separator forming slurry in the same manner as in Example 2 except for using 600 parts by mass of ethylene glycol as the solvent for the separator forming composition. However, since the oligomer did not dissolve in the solvent, no separator forming slurry could be prepared.

### Comparative Example 6

A commercially available polyolefin microporous film (thickness: 20 μm) was used as a separator. The same positive electrode as that produced in Example 1, and the same negative electrode as that produced in Example 1 (the negative electrode including no separator) were stacked together through the separator and were wound in a spiral fashion to produce a wound electrode group. And except for using this wound electrode group, a nonaqueous electrolyte secondary battery was produced in the same manner as in Example 1.

Each of the following evaluations was performed on the separators of the nonaqueous electrolyte secondary batteries of Examples and Comparative Examples.

### <Measurement of Tg of Crosslinked Resin>

The separator forming compositions prepared in Examples 1 to 3 and

Comparative Examples 1 to 4 were applied to polytetrafluoroethylene sheets, respectively, and irradiated with ultraviolet rays with a wavelength of 365 nm for 10 seconds at intensity of 1000 mW/cm², followed by drying at 60° C. for 1 hour, thus forming porous films having a thickness of 20 μm and containing crosslinked resins such as the resin (A). And by using each of these porous films, Tg of each separator forming crosslinked resin was measured by the above-described method.

### <Measurement of Air Permeability of Separators>

The Gurley value of each of the separators of Examples 1 to 3 and Comparative Examples 1 to 4 and 6 was determined by the method according to JIS P 8117, and this value was taken as the air permeability of each separator. The Gurley value can be defined as the time (in seconds) during which 100 mL of air permeates through a film under a pressure of 0.879 g/mm². In measuring the air permeability of the separators of Examples 1 to 3 and Comparative Examples 1 to 4, the porous films produced for the measurement of Tg of the crosslinked resins were used.

### <Measurement of Average Pore Size of Separators>

The average pore size of each of the separators of Examples 1 to 3 and Comparative Examples 1 to 4 was measured based on the bubble point method according to JIS K 3832. In measuring the average pore size, the porous films produced for the measurement of Tg of the crosslinked resins were used.

### <Measurement of Shape and Circularity of Pores of Separators>

A cross section of each of the separators of Examples 1 to 3 and Comparative Examples 1 to 4 and 6 was observed with a scanning electron microscope (SEM), and the shape of pores was evaluated visually. Further, from the cross section observed with the SEM, the area S (mm²) and the circumferential length L (mm) of 130 pores were determined, and the circularity of each pore was calculated using the following formula. An average determined by dividing the total of circularity values by the number of the pores was taken as the circularity of each separator.

Circularity=(4×π×S)/L²

### <Measurement of Thermal Shrinkage of Separators>

A 5 cm long and 10 cm wide rectangular piece was cut from each of the separators of Examples 1 to 3 and Comparative Examples 1 to 4 and 6, and a 3 cm line parallel to the vertical direction and a 3 cm line parallel to the horizontal direction were marked on each rectangular piece in the shape of a cross with black ink. The separator pieces were cut from the separators such that the vertical direction of each separator piece corresponded to the machine direction (MD) of the resin porous film as a separator component, and the point of intersection of the two lines was at the center of each separator piece. Then, the separator pieces were hung in a thermostatic oven whose internal temperature was set to 175° C. And after one hour, the separator pieces were taken out from the thermostatic oven and were cooled. Thereafter, for the smaller of the two lines in the shape of a cross, the length d (mm) was measured, and the thermal shrinkage (%) was calculated using the following formula.

Thermal shrinkage=100×(30−d)/30

In measuring the air permeability of the separators of Examples 1 to 3 and Comparative Examples 1 to 4, the porous films produced for the measurement of Tg of the crosslinked resins were used.

Further, each of the following evaluations was performed on the nonaqueous electrolyte secondary batteries of Examples 1 to 3 and Comparative Examples 1 to 4 and 6.

### <Thermal Test at 175° C.>

Each of the nonaqueous electrolyte secondary batteries of Examples and Comparative Examples was charged at a constant current of 0.2 C until the battery voltage became 4.2 V, and then was charged at a constant voltage of 4.2 V. The total charging time from the beginning of the constant current charging to the end of the constant voltage charging was 10 hours. Each of the charged batteries was placed in a thermostatic oven set to 175° C. and was left there for 60 minutes. Subsequently, each of the batteries was taken out from the thermostatic oven to undergo cooling, and then the voltage of each of the batteries was measured. Further, after the measurement of the voltage, each of the batteries was disassembled to observe the appearance of the separator visually.

### <Charge-Discharge Test (Evaluation of Load Characteristics)>

Each of the nonaqueous electrolyte secondary batteries of Examples and Comparative Examples (different batteries from those that underwent the thermal test at 175° C.) was charged at a constant current and at a constant voltage under the same conditions as in the thermal test at 175° C., and was discharged at a constant current of 0.2 C until the battery voltage became 2.5 V to measure the discharge capacity (discharge capacity at 0.2 C). Then, each of the batteries was charged at a constant current and then at a constant voltage under the same conditions as above, and was discharged at a constant current of 2 C until the battery voltage became 2.5 V to measure the discharge capacity (discharge capacity at 2 C). And the discharge capacity retention of each battery was determined by dividing the discharge capacity at 2 C by the discharge capacity at 0.2 C and expressing the obtained value in percentage. The larger the discharge capacity retention, the better the load characteristics of the battery.

### <Evaluation of Charge-Discharge Cycle Characteristics>

Each of the nonaqueous electrolyte secondary batteries of Examples and Comparative Examples (different batteries from those that underwent the thermal test at 175° C. and the charge-discharge test) was charged at a constant current of 1 C until the battery voltage became 4.2V, and then was charged at a constant voltage of 4.2V The total charging time from the beginning of the constant current charging to the end of the constant voltage charging was 3 hours. Then, each of the charged batteries was discharged at a constant current of 1 C until the battery voltage became 2.5 V Cycles of charging and discharging were repeated 300 times, where a series of charging at a constant current and at a constant voltage and discharging was taken as one cycle. Then, the discharge capacity retention of each of the batteries was determined by dividing the discharge capacity at the 300th cycle by the discharge capacity at the 1st cycle and expressing the obtained value in percentage. The larger the discharge capacity retention, the better the charge-discharge cycle characteristics of the battery.

Table 1 provides the results of evaluating the separators, and Table 2 provides the results of evaluating the nonaqueous secondary batteries. FIG. 3 is an SEM image showing a cross section of the separator of Example 1. Since the separator of Comparative Example 6 shrunk significantly, its shrinkage rate could not be measured during the measurement of the thermal shrinkage at 175° C. Thus, the relevant cell of Table 1 is labeled “unmeasurable.”

TABLE 1

| | | | | | Thermal |
|---|---|---|---|---|---|
| | Tg of | | | | shrinkage at |
| | crosslinked resin | Air permeability | Average pore size | | 175° C. |
| | (° C.) | (sec/100 mL) | (μm) | Circularity | (%) |
| Ex. 1 | 52 | 80 | 0.082 | 0.53 | 0.30 |
| Ex. 2 | 19 | 150 | 0.055 | 0.65 | 0.25 |
| Ex. 3 | 1 | 350 | 0.031 | 0.72 | 0.22 |
| Comp. Ex. 1 | 90 | 25 | 3.3 | 0.81 | 0.47 |
| Comp. Ex. 2 | 90 | 40 | 2.1 | 0.48 | 0.55 |
| Comp. Ex. 3 | −40 | >600 | 0.009 | 0.81 | 0.21 |
| Comp. Ex. 4 | 19 | >600 | 0.007 | 0.86 | 0.23 |
| Comp. Ex. 6 | — | 400 | — | 0.43 | Unmeasurable |

TABLE 2

| | | | | Charge-discharge cycle |
|---|---|---|---|---|
| | | | Load characteristics | characteristics |
| | Thermal test at 175° C. | | Discharge capacity | Discharge capacity |
| | Battery voltage | Appearance | retention | retention |
| | (V) | of separator | (%) | (%) |
| Ex. 1 | 3.8 | No significant change | 96 | 94 |
| Ex. 2 | 3.8 | No significant change | 94 | 93 |
| Ex. 3 | 3.8 | No significant change | 90 | 90 |
| Comp. Ex. 1 | 0.1 | Peeled | 12 | 10 |
| Comp. Ex. 2 | 0.3 | Peeled | 25 | 40 |
| Comp. Ex. 3 | 3.8 | No significant change | 18 | 23 |
| Comp. Ex. 4 | 3.8 | No significant change | 10 | 20 |
| Comp. Ex. 6 | 0.1 | Shrunk | 85 | 83 |

As can be seen from Tables 1 and 2, the nonaqueous electrolyte secondary batteries of Examples 1 to 3, each of which included the separator obtained by polymerizing at least an oligomer by irradiation with an energy ray and having adequate average pore size, air permeability, and thermal shrinkage at 175° C., had excellent load and charge-discharge cycle characteristics as their discharge capacity retentions obtained in both the load characteristic evaluation and the charge-discharge cycle characteristic evaluation were higher than those of the nonaqueous electrolyte secondary battery of Comparative Example 6 using a conventional polyolefin microporous film separator. As is clear from FIG. 3, the separator used in the nonaqueous electrolyte secondary battery of Example 1 had a number of three-dimensional pores with no anisotropy. As a result of the SEM observations of the separators used respectively in the nonaqueous electrolyte secondary batteries of Examples 2 and 3, it was found that the pores of the separators had the same shape as that of the pores of the separator used in the nonaqueous electrolyte secondary battery of Example 1.

The nonaqueous electrolyte secondary battery of Comparative Example 6 using a conventional polyolefin microporous film separator underwent a significant decline in the battery voltage in the thermal test at 175° C. due to the shrinkage of the separator. On the other hand, the nonaqueous electrolyte secondary batteries of Examples 1 to 3 were able to maintain high voltage even after the thermal test at 175° C., showing an excellent level of reliability Further, they had an excellent level of safety as no significant change was seen in their separators.

In contrast, for the batteries of Comparative Examples 1 and 2, each of which included a separator containing a crosslinked resin obtained by polymerizing only a monomer by energy ray irradiation, their discharge capacity retentions obtained in both the load characteristic evaluation and the charge-discharge cycle characteristic evaluation were small. Further, it was found in each of the batteries that the separator peeled off from the negative electrode after the thermal test at 175° C. The average pore size of the separators used in the batteries of Comparative Examples 1 and 2 was too large. And as a result of the cross-sectional observations with an SEM, it was found that the pores were less uniform and the separators were peeled off from the negative electrodes. Due to these facts, it is considered that the load and charge-discharge cycle characteristics were impaired.

The battery of Comparative Example 3 also included a separator containing a crosslinked resin obtained by polymerizing only a monomer by energy ray irradiation. Its discharge capacity retentions obtained in both the load characteristic evaluation and the charge-discharge cycle characteristic evaluation were small probably because the lithium ion permeability was small due to the air permeability being too high.

The battery of Comparative Example 4 included a separator made from a separator forming composition using methyl ethyl ketone as the only solvent. Its discharge capacity retentions obtained in both the load characteristic evaluation and the charge-discharge cycle characteristic evaluation were also small probably because the lithium ion permeability was small due to the air permeability being too high.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

The nonaqueous electrolyte secondary battery of the present invention can be used in a variety of applications in which conventionally-known nonaqueous electrolyte secondary batteries have been used.

### DESCRIPTION OF REFERENCE NUMERALS

1 positive electrode
2 negative electrode
3 separator

1. A separator for use in a nonaqueous electrolyte secondary battery, comprising at least a resin (A) having a crosslinked structure,
wherein the resin (A) having a crosslinked structure is obtained by irradiating with an energy ray at least an oligomer polymerizable by irradiation with an energy ray,
the separator has an average pore size of 0.01 to 0.5 μm,
an air permeability of 45 sec/100 mL or more and less than 590 sec/100 mL, where the air permeability is expressed as a Gurley value, and
a thermal shrinkage of less than 2% at 175° C.

2. The separator according to claim 1, wherein the resin (A) having a crosslinked structure has a glass transition temperature of higher than 0° C. and lower than 80° C.

3. The separator according to claim 1, further comprising inorganic particles (B).

4. The separator according to claim 3, wherein V_{A}/ V_{B} as a ratio between a volume V_{A} of the resin (A) having a crosslinked structure and a volume V_{B} of the inorganic particles (B) is 0.6 to 9.

5. The separator according to claim 1, wherein the resin (A) having a crosslinked structure is obtained by irradiating with an energy ray the oligomer polymerizable by irradiation with an energy ray and a monomer polymerizable by irradiation with an energy ray, and a mass ratio between the oligomer and the monomer of the resin (A) having a crosslinked structure is 65:35 to 90:10.

6. The separator according to claim 1, wherein pores of the separator have a circularity of 0.5 or more and less than 0.8.

7. A nonaqueous electrolyte secondary battery at least comprising as components:
a positive electrode comprising a positive electrode mixture layer formed on a surface of a current collector;
a negative electrode comprising a negative electrode mixture layer formed on a surface of a current collector; and
a porous separator,
wherein the separator is the separator according to claim 1.

8. The nonaqueous electrolyte secondary battery according to claim 7, wherein the separator is integral with at least one of the positive electrode and the negative electrode.

9. A method for producing the separator according to claim 1, comprising the steps of:
applying to a substrate a separator forming composition at least containing the oligomer polymerizable by irradiation with an energy ray, a solvent (a) whose solubility parameter is different from that of the oligomer by ±1.5 or less, and a solvent (b) whose solubility parameter is different from that of the oligomer by ±1.55 or more and ±15 or less;
irradiating with an energy ray a coating of the separator forming composition applied to the substrate to form the resin (A) having a crosslinked structure; and
drying the energy ray-irradiated coating of the separator forming composition to form pores.
